(19) United States
(12) Patent Application Publication
(10) Pub. No.: US 2026/0253096 A1
(43) Pub. Date: Aug. 27, 2026

(54) CATEGORY-BASED TECHNICAL CONSTRUCT FOR DATA COLLECTION AND USAGE

(71) Applicant: Amazon Technologies, Inc., Seattle, WA (US)

(72) Inventors: Bijendra Singh, Cedar Park, TX (US); Sac'i Nakano, Clichy (FR); Michael Burke, Austin, TX (US)

(21) Appl. No.: 19/062,373

(22) Filed: Feb. 25, 2025

(51) Int. Cl. G06Q 30/0204

(52) U.S. Cl. CPC G06Q 30/0204

(57) ABSTRACT

A system can receive affirmative consent provided by an entity relating to entity data associated with performing an action performable by services. The system can determine, based on the action, first categories for which the services are configured to use the entity data. The system can determine, based on the affirmative consent, second categories for which the entity has agreed to allow the entity data to be used. The system can map the second categories to the first categories to generate a set of categories for which the services are allowed to collect and use entity data. The system can execute the service using the set of categories to collect the entity data. The system can tag the collected data with the set of categories to generate a tagged subset of data. The system can execute the service to perform the action using the tagged subset of data.

### BACKGROUND

Many public-facing websites may use data to perform essential functions and/or to perform analytics with respect to the data. It is commonly required for these websites to request consent prior to collecting certain data, prior to using certain data, or a combination thereof.

### BRIEF DESCRIPTION OF THE DRAWINGS

Various embodiments in accordance with the present disclosure will be described with reference to the drawings, in which:

FIG. 1 illustrates a simplified block diagram of a computing environment in which a category-based technical construct can be used to control data collection and usage in accordance with at least one embodiment;

FIG. 2 illustrates a simplified data flow for controlling data collection and usage using a category-based technical construct in accordance with at least one embodiment;

FIG. 3 illustrates a simplified data flow for sharing data between services based at least in part on instructions originating from a category-based technical construct in accordance with at least one embodiment;

FIG. 4 illustrates a flowchart of an example of a process for controlling data collection and usage using a category-based technical construct in accordance with at least one embodiment;

FIG. 5 illustrates an example of an architecture that can include a category-based technical construct that can be used to control data collection and usage in which the architecture includes one or more service provider computers, a user device, and one or more facility computers in accordance with at least one embodiment; and

FIG. 6 illustrates an environment in which various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Certain aspects and features of the present disclosure relate to a category-based technical construct that can be used to control data collection, data usage, or a combination thereof for entity data associated with an entity. The entity may provide consent, or may be prompted to provide consent for different reasons when the entity interacts with a website. For example, if the entity visits an online shopping website, the entity may be prompted to provide affirmative consent for the website to collect certain classes of data, to use certain classes of data, etc. In an example, the website may request that the entity provide affirmative consent. The entity may choose to provide the consent, to provide a partial amount of consent, or to provide no consent. The category-based technical construct may receive the consent provided by the entity, if any, and the category-based technical construct can control which portions of the entity data may be collected and/or used. In some embodiments, the category-based technical construct may map affirmative consent provided by the entity to categories of collection and/or usage associated with one or more services executable by the website. The category-based technical construct can tag any entity data collected with categories for which the collected data are allowed to be stored and/or used. The tags can persist indefinitely and be available for use even after transferring the data to a different service, system, or the like.

The category-based technical construct can provide various improvements over other systems. For example, the category-based technical construct can ensure that less (including no) data is wasted by ensuring that services know how to properly use or store data. By using categories in the context of the category-based technical construct, at least data security and usage, such as usage efficiency, are improved over the other systems.

In an example, an entity, such as a user of a client device, can interact with a website, such as via an application, that can provide one or more services, and the interaction can include a request to perform an action such as to acquire a good or requisition a service. In some embodiments, the website can include a backend system with one or more services that can be executed to perform the action. The website can request the entity provide an indication of one or more affirmative consents prior to proceeding with the action or other actions. The entity can, such as via a user interface on the client device, select which, if any, affirmative consents to provide to the website. The website can receive the affirmative consents, which may include at least a consent to collect and/or use essential entity data for executing the requested action. The website can execute, or make a call to execute, the category-based technical construct, which can map the affirmative consents to one or more purposes for collecting, storing, and/or using the entity data, can control how entity data is collected, stored, and/or used. In some embodiments, a purpose can define the reason or rationale for accessing, storing, or otherwise using a specific data element. Reasons for access, storage, and use should be consistent with common sense and be legally permissible such as based at least in part on applicable privacy compliance laws.

In some embodiments, examples of purposes or categories can include:
Providing real-world items and services: delivering the real-world items and services, managing accounts and resource transfers, providing interaction support, adjusting device settings, etc.
Analysis and innovation: improving services offered to entities, conducting analysis for gaining insights on historical and potential future interactions for enhancing experiences provided to the entities.
Recommendations and personalization: providing personalized item and/or content recommendations and customizing a user experience based on entity data.
Content recommendation: managing content recommendation preferences, selecting relevant content (e.g., ads), measuring content performance, etc.
Security and troubleshooting: ensuring data and system security, troubleshooting issues, providing physical security, etc.
Legal rights and obligations: complying with relevant laws and regulations.
Fraud or crime prevention: complying with regulations to prevent abuse of resource transfers, preventing fraud and abuse, assessing risk, etc.

In some embodiments, the category-based technical construct can map purposes, or categories, indicated by the affirmative consent provided by the entity to categories of data access, storage, and usage for which the one or more services are configured to use. That is, the one or more services are each configured to collect and/or use certain data, while configured to not collect and/or use other data. The category-based technical construct can determine which specific data elements are configured to be collected and/or used and can map the categories indicated by the affirmative consent to the specific data elements. In some embodiments, some data collected and/or used by the one or more services may not be consented to be collected and/or used by the entity, and the category-based technical construct can prevent the one or more services from collecting and/or using the respective data. In some embodiments, the category-based technical construct can tag collected data with specific categories that can guide the one or more services in how to properly use and/or store the tagged data, for example to prevent unauthorized use, storage, and/or disclosure of the data even after an initial use of the data and after sharing the data with other services.

A system, such as the category-based technical construct described herein, can be used to control collection and usage of entity data. The system can receive, such as at an application associated with a backend processing system, an interaction from a client device. In some embodiments, the interaction includes a request for the application to cause the backend processing system to perform an action using one or more services. The system can provide, such as to the client device, an interactive user interface for requesting one or more consents for entity data to be collected or used based at least in part on the action. The system can receive, such as from the client device and based at least in part on the interactive user interface, an indication of affirmative consent provided by an entity for the one or more consents. The system can determine, such as based at least in part on the action, one or more first categories for which the one or more services are configured to collect and use the entity data. The system can determine, such as based at least in part on the affirmative consent, one or more second categories for which the entity has agreed to allow the entity data to be collected and used. The system can map the one or more second categories to the one or more first categories to generate a set of categories for which the application or the one or more services are allowed to collect and use the entity data. In some embodiments, the set of categories includes a set of collection categories and a set of usage categories. The system can execute the application using the set of collection categories to collect a subset of the entity data according to the affirmative consent provided by the entity. The system can tag the subset of the entity data with the set of collection categories and the set of usage categories to generate a tagged subset of the entity data. The system can execute the one or more services to perform the action using the tagged subset of the entity data.

In some embodiments, a cookie consent banner can be provided to an entity via an interactive user interface after the entity accesses a website. The banner may request consent for:
Gathering/using data for purposes that are necessary technical operations of the offered web service.
Gathering/using data for personalization of the customer experience.
Gathering/using data for advertisement purposes.
Gathering/using data for performance control or monitoring of the website.
Gathering/using data for other suitable purposes.

The category-based technical construct disclosed herein can map granted entity consent to a well-defined set of permitted purposes or categories. Any categories not expressly approved by the entity, and that are not required for performing essential functions or requested actions, may be marked as not permitted or otherwise prevented from being executed. When entity data is gathered, the entity data can be tagged by the category-based technical construct with permitted purposes or categories. Each system or service that collects or uses entity data can declare the purposes or categories for collecting and using the entity data. Upon use, the purpose for using the entity data is validated against the permitted purposes or categories prior to execution. For example, if the data use purpose matches the consent-granted purpose, then the use is allowed, otherwise the use is denied or otherwise prevented.

In some embodiments, categories can vary among different services and consents. Some examples of generic categories can include data access or storage purposes, auxiliary purposes, measurement purposes, and the like. Data access or storage purposes can involve controlling access to protected or personal information. Auxiliary purposes can include support categories that can facilitate validations so the primary purpose of data access can be achieved. In an example, to complete an acquisition request, an account of the entity may need to be accessed, which may be the data access purpose. A malicious intent check may be performed prior to performing the primary action, and the malicious intent check may be the auxiliary purpose. Measurement purposes or categories may be used for performing system and/or technical measurements, which may depend on, or may be independent from, the data access purpose or the auxiliary purpose.

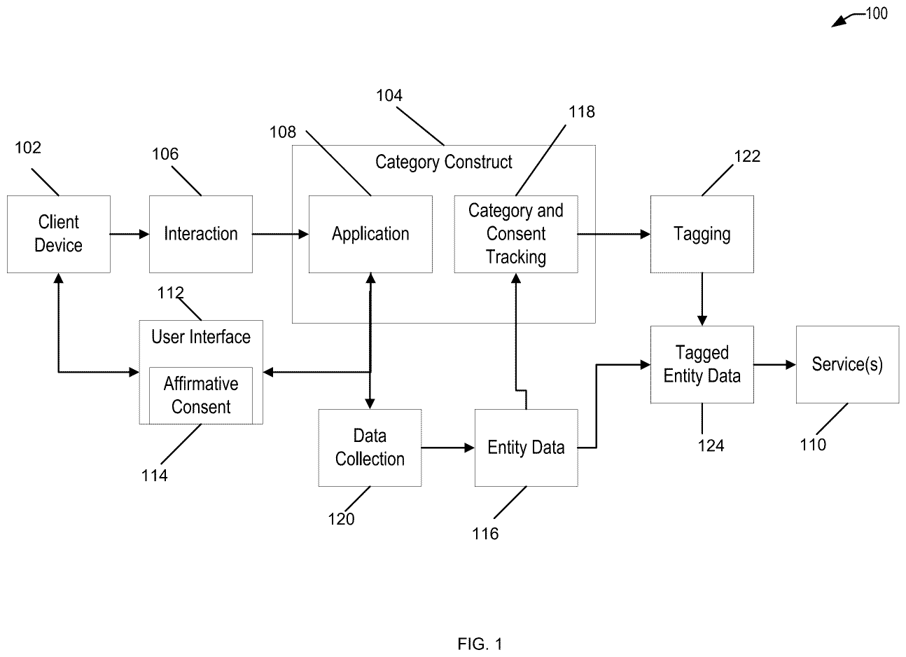

FIG. 1 illustrates a simplified block diagram of a computing environment 100 in which a category-based technical construct can be used to control data collection and usage in accordance with at least one embodiment. As illustrated in FIG. 1, the computing environment 100 can include at least a client device 102 and a category construct 104, such as the category-based technical construct described above, though the computing environment 100 can include any additional, alternative, or fewer components for providing functionality for the computing environment 100. The client device 102 may be or include a mobile computing device, such as a smartphone or tablet, may be or include a personal computing device, such as a desktop computer or a laptop computer, or may be or include any other suitable type of client device that can be used to access a website. The client device 102 may be used to interact, such as at least indirectly, with the category construct 104 via an interaction 106. The interaction 106 may include or be transmitted via an application programming interface (API) call to the category construct 104 or any component or service thereof. In some embodiments, the interaction 106 may include a request that a user of the client device 102 has caused to be generated for an action to be performed such as by an application 108 or by the website.

In some embodiments, the category construct 104 may be embedded within or otherwise accessible by the website. That is, when the client device 102 transmits the interaction 106 to the application 108, the client device 102 may be interacting with the website, which can then interact with the application 108 such as via a backend process not accessible to the client device 102. Additionally or alternatively, the interaction 106 may include instructions for causing the website, or one or more services 110 associated with the website, to perform the action. In some embodiments, the action can include a request to acquire a service or real-world item, a request to update a security account associated with the user of the client device 102, a request to access data hosted or otherwise provided by the website, or other suitable actions. The interaction 106 can be received by the category construct 104, such as via the website, and the category construct 104, or the website, can transmit a user interface 112 to the client device 102 for requesting affirmative consent 114 from the user of the client device 102.

In some embodiments, the user interface 112 may be or include a graphical, interactive user interface with which the user of the client device 102 can interact via the client device 102. The user interface 112 may include sliders, interactive buttons, interactive fields, or the like to allow the user of the client device 102 to indicate the affirmative consent 114. In some embodiments, and prior to providing a user interface that includes a request for the affirmative consent from the entity, the category construct 104 may determine if the affirmative consent 114 already exists for the entity. If the affirmative consent 114 was already provided by the entity, or otherwise already exists for the entity, the category construct 104 may not request consents from the entity via the user interface 112. The affirmative consent 114 may relate to collection, storage, and/or usage of entity data 116 associated with the user of the client device 102. The user of the client device 102 may choose to provide consent for all instances of collecting, storing, and using the entity data 116. In some embodiments, the user of the client device 102 may choose to provide consent to a portion of, or none of, the instances of collecting, storing, and using the entity data 116. In instances in which the user of the client device 102 decides to provide no consent with the affirmative consent 114, the affirmative consent 114 may still include consents for certain instances of data collection, storage, and/or usage. For example, the certain instances may involve collecting, storing, and/or using data of the entity data 116 that may be required for processing the requested action or providing other essential functionality for the website, the one or more services 110, the application 108, etc. Being required may mean that without the collected, stored, and/or used data, the action may not be able to be performed, etc.

The user interface 112 may facilitate selection of consents to include in the affirmative consent 114, and the user interface 112 can transmit the affirmative consent 114 to the application 108 or other suitable component or service of the category construct 104. The affirmative consent 114 may be transferred to a category and consent tracking module 118 that can determine categories based at least in part on the affirmative consent 114. In some embodiments, the category and consent tracking module 118 may be in at least indirect communication with the one or more services 110 or may otherwise have information about how the one or more services 110 operate. That is, the category and consent tracking module 118 can determine data that each service of the one or more services 110 is configured to collect, store, and/or use. Each service of the one or more services 110 may be configured to collect, store, and/or use different sets of data of different sizes and types. For example, a first service may only collect, store, and use a name and an address of the user, while a second service may collect and store resource information about the user while only using a name, an address, and other account information about the user. The category and consent tracking module 118 can receive or parse the interaction 106 to determine the action requested to be performed, and the category and consent tracking module 118 can identify services of the one or more services 110 that may perform the action. Of the identified services, the category and consent tracking module 118 can determine a first set of categories of data of the entity data 116 that the identified services are configured to collect, store, and/or use. In some embodiments, the determined categories may be or include purposes that can define the reason or rationale for accessing, storing, or otherwise using a specific data element. Reasons for access, storage, and use should be consistent with common sense and be legally permissible such as based at least in part on applicable privacy compliance laws.

Upon determining the first set of categories based on the one or more services 110, the category and consent tracking module 118 can determine a second set of categories based on the affirmative consent 114 provided via the client device 102. For example, the category and consent tracking module 118 can determine categories for data collection, storage, and/or usage for which the user has indicated approval based on the affirmative consent 114. The first set of categories and the second set of categories may be similar or identical, or the first set of categories and the second set of categories may be different from one another. The category and consent tracking module 118 can map the second set of categories to the first set of categories, or vice versa, to determine which categories approved by the user exist in the first set of categories associated with the one or more services 110. In embodiments in which each category of the first set of categories is present in, or can be mapped to, the second set of categories, then the one or more services 110 may be allowed to proceed without alteration. In embodiments in which there is at least one category present in the first set of categories that is not present in the second set of categories, then the category and consent tracking module 118 may alter a function of a respective service of the one or more services 110 to prevent the respective service from collecting, storing, or using data based on the at least one category.

In some embodiments, data collection 120 may be performed prior to the mapping performed by the category and consent tracking module 118. That is, in response to receiving the affirmative consent 114 from the client device 102, the category construct 104, or any component or service thereof, may collect the entity data 116 and provide the affirmative consent 114, the entity data 116, and any other suitable information to the category and consent tracking module 118 for adjusting, if necessary, a configuration of the one or more services 110. In some embodiments, if the category and consent tracking module 118 determines that some data of the entity data 116 was not consented to be collected, the category and consent tracking module 118 may delete the data or otherwise tag the data to be deleted or otherwise not stored. The category and consent tracking module 118 may perform additional tagging operations, such as via tagging 122, to tag the remaining data allowed to be stored and/or used by tagging each data element with a set of categories for which the respective data elements are allowed to be stored and/or used.

The tagging 122 may include one or more operations that can be performed by the category construct 104, by the category and consent tracking module 118, or any other component or service of the category construct 104 to tag each data element or each set of data elements with categories approved by the user of the client device 102. In some embodiments, the tagging 122 can involve augmenting the entity data 116 with a category table that can persist through usage of the entity data 116 and through sharing of the entity data 116 with potentially infinitely many different services. That is, regardless of how the entity data 116 is used or what uses the entity data 116, the tags applied to the entity data 116 may persist and guide how the entity data 116 is used and/or stored. In some embodiments, after the tagging 122, the entity data 116 may be transformed into tagged entity data 124. The tagged entity data 124 can include the category table, can include an additional column that indicates tags for approved categories, or may otherwise suitably include the tags.

In some embodiments, the tagged entity data 124 can be provided to the one or more services 110 to cause the one or more services 110 to perform the action requested by the user of the client device 102. The category construct 104, or any component, service, or module thereof, can transmit the tagged entity data 124 to the one or more services 110, and the one or more services 110 can perform the action according to the tags applied to the tagged entity data 124. In some embodiments, the one or more services 110 may perform one or more additional actions based on the tags applied to the tagged entity data 124. For example, the tags applied to the tagged entity data 124 may indicate that the user has approved the entity data 116 to be used to tailor recommended content to the user, so the one or more services 110 may perform an auxiliary action to update content recommendations provided for the user. Additionally or alternatively, the tags applied to the tagged entity data 124 may indicate that the user has approved the entity data 116 to be used to personalize an experience provided to the user via the website. So, the one or more services 110 may perform an auxiliary action to adjust an experience provided to the user via the website based at least in part on the tagged entity data 124. The one or more services 110 may perform a suitable number of auxiliary actions, if any, based on the tags applied in the tagged entity data 124.

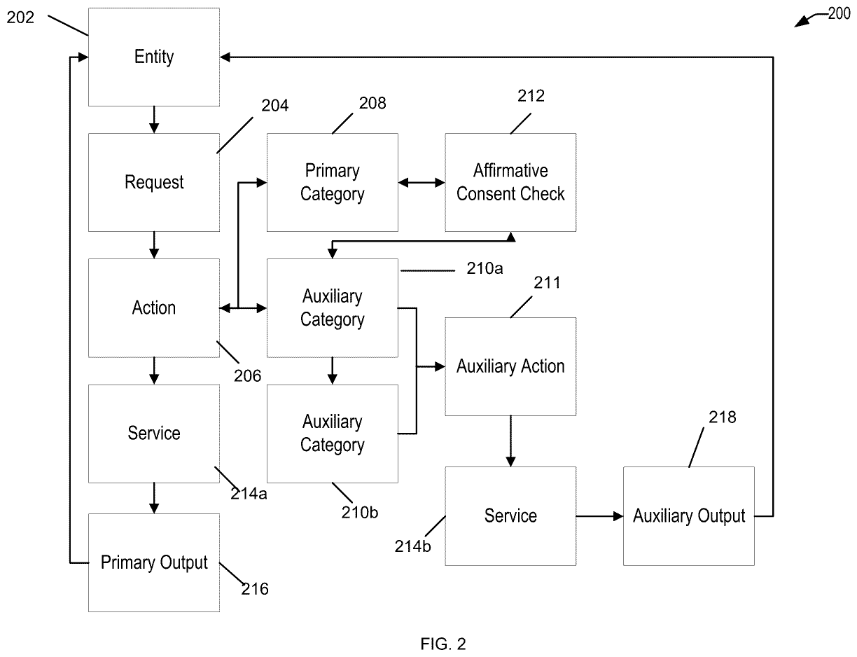

FIG. 2 illustrates a simplified data flow 200 for controlling data collection and usage using a category-based technical construct, such as the category construct 104, in accordance with at least one embodiment. As illustrated in FIG. 2, the simplified data flow 200 can begin with an entity 202, which may be similar or identical to the user of the client device 102. For example, the entity 202 may be or include an individual or an organization that can operate the client device 102 to interact with a website or other public network location that may embed or otherwise have access to the category construct 104. The entity 202 can operate the client device 102, or other suitable computing device, to generate and submit an interaction to the website or other public network location. The interaction may be similar or identical to the interaction 106 illustrated and described with respect to the computing environment 100 in FIG. 1. For example, the interaction may include a request 204 for the website or any service thereof to perform an action 206. In some embodiments, the action 206 can include providing a real world item or service to the entity 202, updating a security account associated with the entity 202, accessing data hosted or provided by the website or public network location, etc.

The action 206 can be evaluated by the category construct 104, or any component, service, or module thereof (e.g., the application 108 or the category and consent tracking module 118), and the category construct 104 can determine a primary category 208 associated with the action 206 and one or more auxiliary categories, such as auxiliary category 210a and auxiliary category 210b, if any, associated with the action 206. In some embodiments, the primary category 208 may include a category of data usage, storage, or collection that directly facilitates or allows the action 206 to be performed by a service. Additionally or alternatively, the one or more auxiliary categories, if present, may include categories of data usage, storage, or collection that can enable other actions, such as an auxiliary action 211 not directly related to the action 206, to be performed.

The primary category 208, and any auxiliary category, can be evaluated, such as by the category construct 104 or any service, component, or module thereof, against the affirmative consent 114, at affirmative consent check 212, provided by the entity 202 prior to performing any actions. For example, the category construct 104, or any service, component, or module thereof, can determine (i) a first set of categories associated with services that are configured to perform the action 206 and any potential auxiliary actions and (ii) a second set of categories associated with the affirmative consent 114 provided by the entity 202. The second set of categories associated with the affirmative consent 114 may indicate for which purposes (categories) data associated with the entity 202 are allowed to be used, and the first set of categories may indicate for which purposes (categories) data is collected, stored, used, etc. by the services. If the first set of categories does not match the second set of categories, then an adjustment may be made prior to using any entity data to perform the action 206 or any auxiliary actions.

In some embodiments, the category construct 104, or any component, service, or module thereof, can map the second set of categories to the first set of categories. Mapping the second set of categories to the first set of categories can involve determining whether each category of the second set of categories is present in the first set of categories. If there is a category in the first set of categories that is not present in the second set of categories, then one or more services associated with the category, or the actions performed by the one or more services, may be altered prior to providing data to the one or more services. For example, the one or more services may be prevented from using, storing, or collecting data according to the category.

In some embodiments, the category construct 104, or any component, service, or module thereof, can tag entity data gathered based on the request 204 based on mappings between the first set of categories and the second set of categories. For example, each data element authorized by the entity 202 to be collected, stored, and/or used for a particular category can be augmented, such as via a category table or a category column, to indicate that the data element can be collected, stored, or used according to the particular category. An absence of a tag for a particular category for the data element may indicate that the data element has not been consented to be collected, stored, and/or used according to the particular category, and services may be prevented from collecting, storing, or using the data element for the particular category.

In some embodiments, and in response to completing the affirmative consent check 212, the category construct 104, or any service, component, or module thereof, can determine whether the action 206 can be performed and whether any additional actions can be performed based on the consents provided by the entity 202. In response to determining that the action 206 cannot be performed using the data consented to by the entity 202, the category construct 104 may return an error message to the entity 202, may request additional consents from the entity 202 for performing the action 206, or may return a notification to the entity 202 informing the entity 202 that some data was gathered, stored, and/or used without consent specifically for performing the requested action 206. Additionally or alternatively, in response to determining that the action 206 can be performed based on the consents provided by the entity 202, the category construct 104 may provide the tagged entity data to a service 214a for performing the action 206. In some embodiments, the service 214a may be configured to collect, store, and/or use at least a portion of the tagged entity data according to categories approved by the entity 202 for performing the action 206. The service 214a can consume the tagged entity data and can generate a primary output 216 that can be transmitted to the entity 202 as confirmation that the action 206 has been performed. In some embodiments, the primary output 216 can include a notification that the action 206 was successfully performed, can include an indication that a real-world item or service is pending based on the action 206, or may include any other suitable outputs.

In some embodiments, the second set of categories may indicate that actions different from the action 206 may also be performed based on the tagged entity data. For example, the second set of categories may include content recommendation categories, account personalization categories, and the like. These categories, which may include auxiliary category 210a and auxiliary category 210b, may allow the auxiliary action 211 to be performed such as independent of, or in conjunction with, the action 206. The tagged entity data can be provided to service 214b, which may be similar to or different from the service 214a, to perform the auxiliary action 211. The service 214b can generate an auxiliary output 218 that can be provided to the entity 202. In some embodiments, the auxiliary output 218 can include an adjusted user interface based on personalization parameters adjusted by the services 214b based on the tagged entity data. Additionally or alternatively, the auxiliary output 218 can include content recommendations generated based at least in part on the tagged entity data. Other suitable auxiliary outputs are possible for the auxiliary output 218 for providing to the entity 202.

In an example, when a service provider receives a request such as a request for a real-world item, the service provider may be associated with the primary purpose (category) of providing application functionality. As a part of fulfilling the request, the service provider may need to perform other functions such as checking for fraud, checking if the requestor has a threshold level of resources to facilitate the action, etc. Thus, the original request may span other supplementary requests with auxiliary purposes (categories), but each request still has a purpose that must match the purpose of data attempted to be accessed or used.

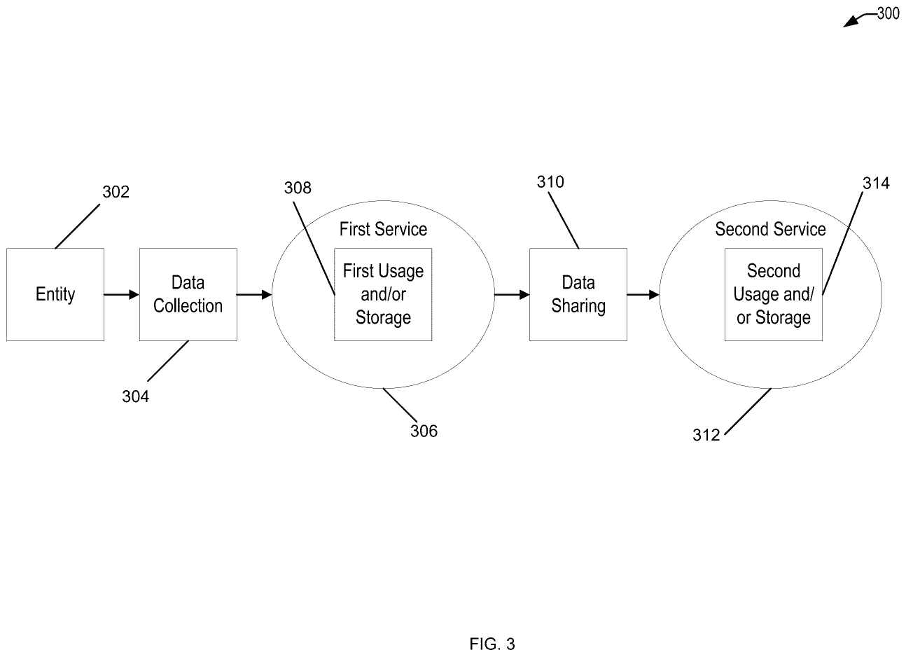

FIG. 3 illustrates a simplified data flow 300 for sharing data between services based at least in part on instructions originating from a category-based technical construct, such as the category construct 104, in accordance with at least one embodiment. As illustrated in FIG. 3, the simplified data flow 300 may begin with an entity 302, which may be similar or identical to the entity 202 illustrated and described with respect to FIG. 2. The entity 302 may submit a request to a website, and the website may perform data collection 304 that may cause entity data associated with the entity 302 to be collected. The entity data collected via data collection 304 may include all possible data associated with the entity 302 or may include a subset thereof. The subset may include a minimum amount of data gathered to be able to fulfill the request provided by the entity 302. In some embodiments, the subset may include data gathered according to instructions provided by the category construct 104. The instructions may include or may be derived from tagged entity data tagged according to mapped categories between services configured for executing an action indicated by the request and consents provided by the entity 302.

The collected entity data can be provided to a first service 306 that can perform one or more actions via first usage and/or storage 308. In some embodiments, the first usage and/or storage 308 can involve using and/or storing data collected via the data collection 304 according to the instructions provided by the category construct 104. In an example, the first usage and/or storage 308 may involve executing the first service 306 to perform the action requested to be performed by the entity 302. A result of the first usage and/or storage 308 can include an output that can be provided to the entity 302. The output can include a notification that a real-world item or service has been confirmed as provided (or to be provided in the future) to the entity 302, can include an updated to a personalization setting requested by the entity 302, other suitable outputs, or any combination thereof. In some embodiments, the first usage and/or storage 308 can involve storing the collected and/or used data in a specific location according to the instructions provided by the category construct 104. For example, the instructions may prevent the collected data to be stored in a location publicly accessible or otherwise accessible to other computing devices not associated with the first service 306.

Upon execution, which may be successful or not successful, of the first service 306, for example via the first usage and/or storage 308, the collected data can be shared, such as via data sharing 310, with a separate service with respect to the first service 306. In some embodiments, the data sharing 310 may be an explicit or express decision made by the first service 306 such as via the first usage and/or storage 308. For example, the first service 306 may perform the first usage and/or storage 308, which may include a decision for the first service 306 to perform the data sharing 310 to transmit the collected data to a second service 312, which may include a single service separate from the first service 306 or may include more than one service, that can be configured to receive the transmitted data at least partially simultaneously, separate from the first service 306. The collected data can be transmitted to the second service 312 that can be used to perform a second usage and/or storage 314. In some embodiments, transmitting the collected data via the data sharing 310 can include transmitting the instructions from the category construct 104 with the collected data to the second service 312. The instructions may be or include a category table, a data column listing categories, or other suitable instructions that clearly indicate which categories or use and/or storage each data element of the collected data has been consented to by the entity 302. The second service 312 can receive, as a result of the data sharing 310, the collected data and the instructions, and the second service 312 can parse the received data and instructions to configure the second usage and/or storage 314 according to the instructions. For example, the second service 312 can determine, or can receive, instructions that indicate that the received data may only be used for a set of usage categories that may include fewer categories than a second set of categories representing categories for which the second service 312 is configured to use and/or store data. Based on determining or receiving the instructions, the second service 312 may be limited to using and/or storing data only according to the categories included in, or otherwise indicated by, the instructions.

In some embodiments, the second service 312 may be or include a service for performing an auxiliary action that may not have been directly requested to be performed by the entity 302. For example, the second service 312 may be configured to personalize an experience provided by the website for the entity 302, may be configured to generate content recommendations for the entity 302 based on data and/or interactions associated with the entity 302, or may otherwise be configured to perform other suitable auxiliary actions. The second service 312 may perform the auxiliary action if the collected data includes a sufficient type and amount of data and if the instructions are consistent with performance of the auxiliary action. An output of the auxiliary action can be provided to the website, to the entity 302, to other suitable devices or entities, or to any suitable combination thereof. Upon completion of the auxiliary action via the second usage and/or storage 314, the second service 312 may store the collected data in a location consistent with the instructions, may transmit the collected data to a separate service, may delete the collected data consistent with the instructions, or any suitable combination thereof. In embodiments in which the second service 312 stores the collected data and/or transmits the collected data to a separate service, the second service may retain the instructions with the collected data. That is, regardless of where the collected data is stored or transmitted, the instructions will persist with the collected data and will be accessible to any other service or device that attempts to access the collected data to prevent unauthorized access, use, and/or storage of the collected data that would be inconsistent with the affirmative consent provided by the entity 302.

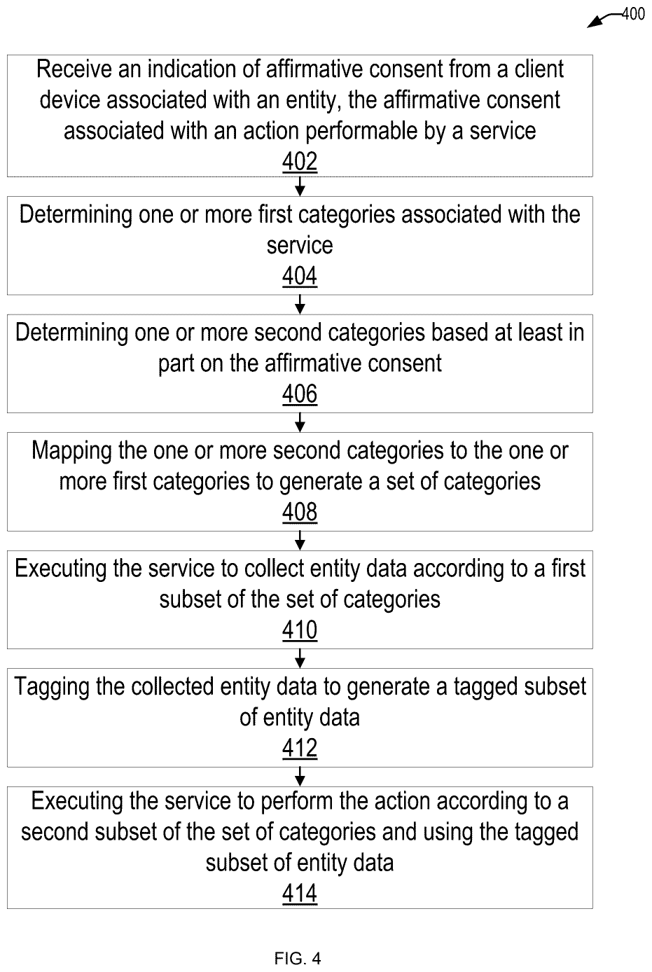

FIG. 4 illustrates a flowchart of an example of a process 400 for controlling data collection and usage using a category-based technical construct in accordance with at least one embodiment. Some or all of the process 400 (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

At block 402, an indication of affirmative consent is received. In some embodiments, the indication of affirmative consent can be received from a client device and can be provided by an entity via the client device. The affirmative consent can include or otherwise indicate one or more consents for collecting and/or using entity data associated with performing an action. In some embodiments, the affirmative consent can include (i) a first consent automatically provided for data essential for functions to facilitate the action and (ii) a second consent optionally provided for additional data associated with functions that are performable based at least in part on the additional data. Additionally or alternatively, the first consent and the second consent can be applied to separate data independently from one another. The action may be configured to be performed one or more services. The one or more services may include services to perform primary actions, auxiliary actions, or a combination thereof. A primary action may be or include an action that is directed requested to be performed by the entity, and an auxiliary action may be or include an action that may not be directly requested to be performed by the entity but may otherwise be performable based on the affirmative consent provided by the entity.

In some embodiments, the affirmative consent can be provided by the entity via the client device based at least in part on a prompt provided via a user interface provided to the client device. The user interface may include a request for the entity to provide indications of whether certain categories of data usage, storage, and/or collection are agreeable for the entity. The certain categories of data usage, storage, and/or collection may be presented as general or broad categories such as “essential”, “personalization”, “content recommendation”, and the like. In some embodiments, more granular categories may be presented via the user interface, an option to provide more granular categories may be available via the user interface, etc. The entity may not have an option to decline categories deemed essential. For example, the user interface may indicate that at least some data associated with the entity may be collected and/or used regardless of the entity providing any consent since the at least some data may be required to perform the action requested by the entity (i.e., without the at least some data, the one or more services may not be able to perform the requested action). The entity may be able to interact, such as via the client device, with the user interface to provide one or more consents for other categories of data usage and/or collection, to not provide the one or more consents, or any combination thereof. A result of the entity's selections can include the affirmative consent, which may be or include a data package that includes indications of the entity's selections. That is, the affirmative consent can be received by a computing device that can parse the affirmative consent to determine which, if any, categories of data usage and/or collection for which the entity has provided consent.

In some embodiments, the category construct 104 can receive an interaction from the client device. The interaction may be received at an application associated with a backend processing system that may be communicatively coupled with, or may otherwise include, the category construct 104. The interaction can include a request from the entity for the application to cause the backend processing system to perform the action using the one or more services. In some embodiments, and in response to the category construct 104 receiving the request, the category construct 104 can provide an interactive user interface to the client device. The interactive user interface can be provided to the client device to request the affirmative consent, or one or more consents included therein, to allow entity data to be collect and/or used based at least in part on the action. The affirmative consent may indicate additional consents beyond collecting and/or using data for performing the action.

At block 404, one or more first categories are determined. The one or more first categories can include categories for which the one or more services are configured to collect and use entity data. For example, a first service of the one or more services can be configured to collect only a name and an address of the entity for performing an action, while a second service of the one or more services may be configured to collect and/or used additional information about the entity to perform the same action or a different action. The category construct 104 can communicate with each service of the one or more services, or a computing device thereof, to determine for which categories of data usage and/or collection the service is configured. In some embodiments, the category construct 104 can generate a first category table that includes an indication of each service of the one or more services and corresponding categories for data usage and/or collection. The first category table can be maintained in real-time. That is, if categories associated with a service are updated, then the category construct 104 can also update the first category table to reflect the updated categories for the service.

At block 406, one or more second categories are determined. The one or more second categories can include categories for which the entity has agreed to allow the entity data to be collected and/or used. The category construct 104 can determine the one or more second categories based at least in part on the affirmative consent. For example, the entity may provide consent for entity data to be used and/or collected for personalizing an experience for the entity on a website associated with the category construct 104. The category construct 104 can receive the affirmative consent and can parse the affirmative consent to determine the one or more second categories that are separate from, and potentially distinct with respect to, the one or more first categories. For example, the category construct 104 can receive the affirmative consent and can unpack the selections made by the entity regarding the categories provided via the user interface, and the category construct 104 can determine to which categories for data usage and/or collection the entity has consented. In some embodiments, the category construct 104 can generate a second category table that includes an indication of each category for data usage and/or collection to which the entity has consented. The second category table can be maintained in real-time. That is, if categories associated with the entity's consent are updated, then the category construct 104 can also update the second category table to reflect the updated categories for the entity. In some embodiments, the second category table, which represents categories corresponding with consents provided by the entity, can be different from the first category table that represents categories corresponding with the one or more services.

At block 408, the one or more second categories are mapped to the one or more first categories to generate a set of categories. In some embodiments, each category included in the set of categories can be a category for which the one or more services are allowed to collect and/or use entity data associated with the entity in view of consents provided by the entity. The category construct 104 can map the one or more second categories to the one or more first categories. In some embodiments, the category construct 104 can perform the mapping by comparing the second category table to the first category table to identify any inconsistencies between the second category table and the first category table. For example, the category construct 104 can determine if any categories are included in the first category table, which indicate categories that the one or more services are configured to implement, that are not included in the second category table, which would indicate that the entity has not consented to the respective category. Any categories satisfying this consideration may be flagged, tagged, omitted from, or otherwise disabled in the set of categories. Any categories included in the one or more first categories but absent from the one or more second categories may be categories for which a service uses and/or collects data but for which the entity did not provide consent. To ensure that the corresponding data is not used in an unauthorized manner, the category construct 104 may take proactive action in preventing unauthorized use or disclosure of the corresponding data.

In some embodiments, the set of categories can include one or more usage categories, one or more collection categories, or a combination thereof. In additional embodiments, the set of categories may additionally include one or more storage and/or access categories. The one or more usage categories can include categories representing how data is allowed to be used or otherwise configured to be used. In an example, a usage category can include using data to generate a content recommendation, using data to perform a requested action, using data to personalize an experience provided by a website, etc. The one or more collection categories can include categories representing how data is allowed to be collected. In an example, a collection category can include collecting personally identifiable information, collecting protected personal information, etc. The one or more storage and/or access categories can include categories representing how data is allowed to be stored and/or accessed. In an example, a storage and/or access category can include locations in which data is allowed to be stored, time limits for retaining data, when to delete data, etc.

At block 410, the one or more services are executed to collect entity data. In some embodiments, the category construct 104 can cause the one or more services to collect the entity data according to the set of categories. The one or more services may collect all possible data associated with the entity to form the entity data. In some embodiments, a subset of all possible data associated with the entity may be collected in response to executing the one or more services. For example, the category construct 104 may limit, such as via instructions consistent with the set of categories, which data may be collected by the one or more services. The category construct 104, or the instructions generated thereby, can prevent the one or more services from collecting data associated with the entity that are not necessary for performing a requested action and that are not expressly consented to by the entity.

At block 412, a subset of the entity data is tagged with the set of categories. The subset of the entity data may include data allowed to be collected and/or stored for various purposes consistent with the request to perform the action and/or consistent with the affirmative consent provided by the entity. Tagging the subset of the entity data can cause a tagged subset of the entity data to be generated. In some embodiments, tagging the subset of the entity data can include adding a column to the subset of the entity data that indicates categories for which a respective data element is allowed to be used, stored, and/or collected. Additionally or alternatively, tagging the subset of the entity data can include augmenting the subset of entity data with a category table corresponding with the set of categories. The category table may indicate categories for which a respective data element of the subset of entity data is allowed to be used, stored, and/or collected. In some embodiments, the category table can track, or can be used to track, substantially contemporaneously with respect to any subsequent updates to affirmative consent, categories of each data element of the subset of the entity data.

At block 414, the one or more services are executed to perform the action using the tagged subset of entity data. In some embodiments, the one or more services can be executed according to a second subset of the set of categories. For example, a first service can be executed to perform the action using the tagged subset of entity data consistent with the set of categories. Additionally or alternatively, a second service can be executed to perform an auxiliary action if the tagged subset of entity data includes sufficient types and/or amounts of data for performing the auxiliary action and if the tagged subset of entity data indicates that the categories used by the second service are consistent with the set of categories.

In some embodiments, executing the one or more services to perform the action includes (i) executing a first service of the one or more services on the tagged subset of the entity data and (ii) transmitting the tagged subset of the entity data and a result of executing the first service to a second service of the one or more services. The category construct 104 can transmit the set of usage categories to the second service to prevent the second service from using the tagged subset of the entity data in an unauthorized manner. Additionally or alternatively, the category construct 104 can receive an updated indication of affirmative consent from the client device, and the updated indication of affirmative consent can indicate different categories than the one or more second categories. The category construct 104 can adjust the set of categories (i) by removing a subset of the set of categories that is not consistent with the different categories and/or (ii) by adding one or more categories to the set of categories that are included in the different categories. Additionally or alternatively, the category construct 104 can adjust tags applied to the tagged subset of the entity data based at least in part on the adjusted set of categories. The category construct 104 can determine that at least some of the tagged subset of the entity data is no longer consented to be stored by the entity. The category construct 104 can delete, or can cause to be deleted, the at least some of the tagged subset of the entity data.

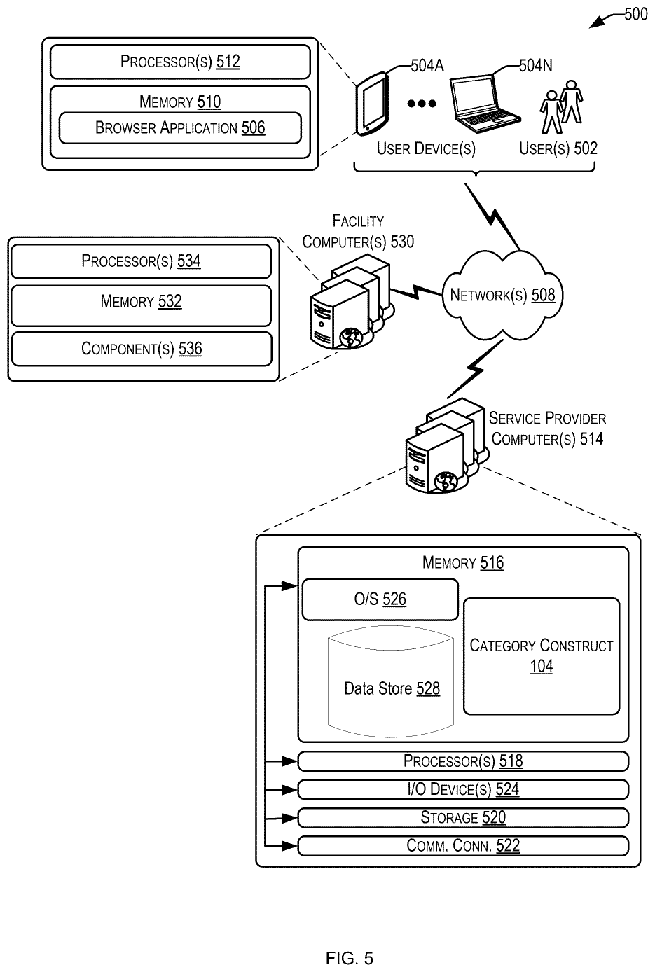

FIG. 5 illustrates an example of an architecture that can include a category-based technical construct, such as the category construct 104, that can be used to control data collection and usage in which the architecture includes one or more service provider computers, a user device, and one or more facility computers in accordance with at least one embodiment. In the architecture 500, one or more users 502, such as contributing entities, combination entities, using entities, and the like, may utilize user computing devices 504A-N (collectively, the user devices 504) to access a browser application 506 or a user interface (UI), such as an interactive user interface, that can be accessed through the browser application 506 and via one or more networks 508, to receive text data, image data, video data, consent data, or the like, which may be presented and interacted with via browser application 506 or the UI accessible through the browser application 506. The browser application 506 can be or include any browser control or native application that can access and/or display a network page or other information. A native application may include an application or program that has been developed for use on a particular platform, such as an operating system, or a particular device such as a particular type of mobile device.

In accordance with at least one embodiment, the user devices 504 may be configured for communicating with service provider computers 514 and facility computers 530 via networks 508. The user devices 504 may include at least one memory, such as memory 510, and one or more processing units or one or more processors 512. The memory 510 may store program instructions that are loadable and executable on the one or more processors 512, as well as data generated during the execution of these programs. Depending on the configuration and type of the user devices 504, the memory 510 may be volatile, such as random access memory (RAM), and/or non-volatile such as read-only memory (ROM), flash memory, etc. The user devices 504 may also include additional removable storage and/or non-removable storage including, but not limited to, magnetic storage, optical disks, and/or tape storage. The disk drives and their associated non-transitory computer-readable media may provide non-volatile storage of computer-readable instructions, data structures, program services, and other data for the user devices 504. In some implementations, the memory 510 may include multiple different types of memory, such as static random access memory (SRAM), dynamic random access memory (DRAM), ROM, etc.

Turning to the contents of the memory 510 in more detail, the memory 510 may include an operating system and one or more application programs or services for implementing the features disclosed herein. Additionally or alternatively, the memory 510 may include one or more services for implementing the features described herein such as the category construct 104 or for displaying or providing an output of the category construct 104.

The architecture 500 may additionally include one or more service provider computers 514 that may, in some examples, provide computing resources such as, but not limited to, client entities, low latency data storage, durable data storage, data access, management, virtualization, hosted computing environment or “cloud-based” solutions, profile identification feature implementation, category mapping, etc. The service provider computers 514 may implement or be an example of the category construct 104, or any component or service thereof or communicatively coupled therewith, described herein, for example, with reference to FIGS. 1-4 and/or throughout the disclosure. The one or more service provider computers 514 may also be operable to provide site hosting, computer application development, and/or implementation platforms, combinations of the foregoing, or the like to the one or more users 502 via user devices 504.

In some examples, the networks 508 may include any one or a combination of many different types of networks, such as cable networks, the Internet, wireless networks, cellular networks, and other private and/or public networks. While the illustrated examples represent the users 502 communicating with the service provider computers 514 over the networks 508, the described techniques may equally apply in instances where the users 502 interact with the one or more service provider computers 514 via the one or more user devices 504 over a landline phone, via a kiosk, or in any other manner, or not at all. It is also noted that the described techniques may apply in other client/server arrangements, such as set-top boxes, etc., as well as in non-client/server arrangements such as locally stored applications, peer-to-peer arrangements, etc. In some embodiments, the users 502 may communicate with the facility computers 530 via networks 508, and the facility computers 530 may communicate with the service provider computers 514 via networks 508. In some embodiments, the service provider computers 514 may communicate, via networks 508, with one or more third party computers to obtain data inputs for the various algorithms of the features described herein. In accordance with at least one embodiment, the service provider computers 514 may receive input data, such as affirmative consents or updated consents from an entity.

The one or more service provider computers 514 may be or include any type of computing devices such as, but not limited to, a mobile phone, a smart phone, a personal digital assistant (PDA), a laptop computer, a desktop computer, a server computer, a thin-client device, a tablet PC, etc. Additionally, it should be noted that in some embodiments, the one or more service provider computers 514 may be executed by one or more virtual machines implemented in a hosted computing environment. The hosted computing environment may include one or more rapidly provisioned and released computing resources, which computing resources may include computing, networking, and/or storage devices. A hosted computing environment may also be referred to as a cloud computing environment or a distributed computing environment. In some examples, the one or more service provider computers 514 may be in communication with the user device 504 via the networks 508, or via other network connections. The one or more service provider computers 514 may include one or more servers, which may be arranged in a cluster or as individual servers not associated with one another. In embodiments, the service provider computers 514 may be in communication with one or more third party computers (not illustrated) via networks 508 to receive or to otherwise obtain data including affirmative consents or the like for at least determining and/or mapping categories for controlling how entity data is used, stored, and/or collected according to consents provided by the entity.

In one illustrative configuration, the one or more service provider computers 514 may include at least one memory, such as memory 516, and one or more processing units or one or more processors 518. The one or more processors 518 may be implemented as appropriate in hardware, computer-executable instructions, firmware, or any combination thereof. Computer-executable instruction or firmware implementations of the one or more processors 518 may include computer-executable or machine-executable instructions written in any suitable programming language to perform the various functions described when executed by a hardware computing device such as a processor. The memory 516 may store program instructions that are loadable and executable on the one or more processors 518, as well as data generated during the execution of these programs. Depending on the configuration and type of the one or more service provider computers 514, the memory 516 may be volatile, such as RAM, and/or non-volatile such as ROM, flash memory, etc. The one or more service provider computers 514 or servers may also include additional storage 520, which may include removable storage and/or non-removable storage. The additional storage 520 may include, but is not limited to, magnetic storage, optical disks and/or tape storage. The disk drives and their associated computer-readable media may provide non-volatile storage of computer-readable instructions, data structures, program services, and other data for the computing devices. In some implementations, the memory 516 may include multiple different types of memory, such as SRAM, DRAM, ROM, etc.

The memory 516, the additional storage 520, removable and/or non-removable, may be examples of non-transitory computer-readable storage media. For example, computer-readable storage media may include volatile or non-volatile, removable or non-removable media implemented in any method or technology for storage of information such as computer-readable instructions, data structures, program services, or other data. The memory 516 and the additional storage 520 may be examples of non-transitory computer storage media. Additional types of non-transitory computer storage media that may be present in the one or more service provider computers 514 may include, but are not limited to, PRAM, SRAM, DRAM, RAM, ROM, EEPROM, flash memory or other memory technology, CD-ROM, DVD, or other optical storage, magnetic cassettes, magnetic tape, magnetic disk storage or other magnetic storage devices, or any other medium which can be used to store the desired information and which can be accessed by the one or more service provider computers 514. Combinations of any of the above should also be included within the scope of non-transitory computer-readable media.

The one or more service provider computers 514 may also include one or more communication connection interfaces 522 that can allow the one or more service provider computers 514 to communicate with a data store, another computing device or server, user terminals, and/or other devices on the networks 508. The one or more service provider computers 514 may also include one or more I/O devices 524, such as a keyboard, a mouse, a pen, a voice input device, a touch input device, a display, speakers, a printer, etc.

Turning to the contents of the memory 516 in more detail, the memory 516 may include an operating system 526, one or more data stores 528, and/or one or more application programs or services for implementing the features disclosed herein including and/or relating to the category construct 104. The architecture 500 may include facility computers 530. In some embodiments, the service provider computers 514 and/or the category construct 104 may be configured to generate and transmit instructions, via networks 508, to components 536 in communication or otherwise associated with facility computers 530. For example, the instructions may be configured to activate or otherwise trigger the components 536 for generating output by the category construct 104. The facility computers 530 may include at least one memory, such as memory 532, and one or more processing units or one or more processors 534. The memory 532 may store program instructions, which may include one or more machine-learning models, one or more computer services, and the like as disclosed herein, that can be loaded and executed on the one or more processors 534, as well as data generated during the execution of these programs. Depending on the configuration and type of the facility computers 530, the memory 532 may be volatile, such as random access memory (RAM), and/or non-volatile such as read-only memory (ROM), flash memory, etc. The facility computers 530 may also include additional removable storage and/or non-removable storage including, but not limited to, magnetic storage, optical disks, and/or tape storage. The disk drives and their associated non-transitory computer-readable media may provide non-volatile storage of computer-readable instructions, data structures, program services, and other data for the facility computers 530. In some implementations, the memory 532 may include multiple different types of memory, such as static random access memory (SRAM), dynamic random access memory (DRAM), ROM, etc.

Turning to the contents of the memory 532 in more detail, the memory 532 may include an operating system and one or more application programs or services for implementing the features disclosed herein. Additionally, the memory 532 may include one or more services for implementing the features described herein including, for example, the category construct 104. In some embodiments, the service provider computers 514, the category construct 104, or a combination thereof can generate output based at least in part on data received from multiple different data sources.

The category construct 104 may be configured to generate and transmit a user interface or data objects for updating a user interface presented via browser application 506 and user device 504 for presenting the output, or any data included therein or inferences determined therefrom, or otherwise associated therewith to the user 502. Other graphical updates, feedback mechanisms, and data object generation associated with the optimization features described herein may be implemented by the service provider computers 514 and/or the category construct 104.

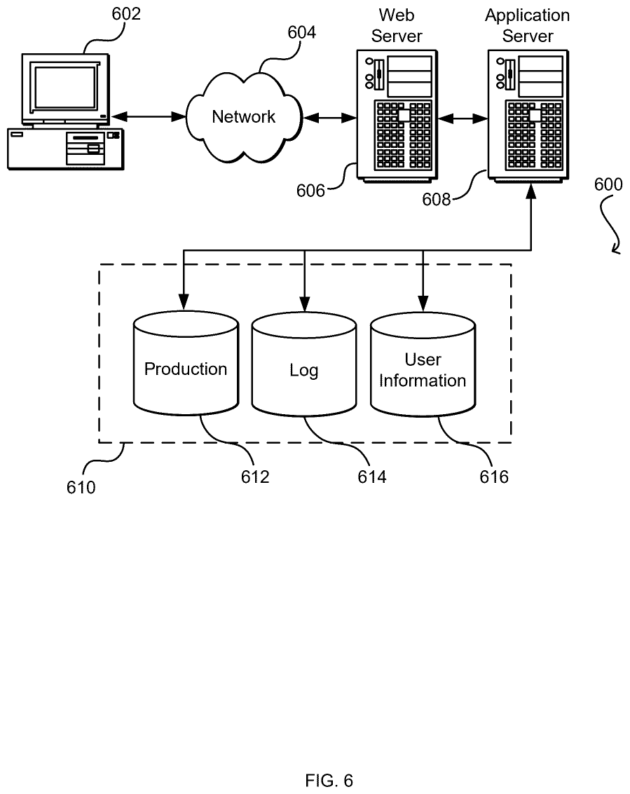

FIG. 6 illustrates aspects of an example environment 600 for implementing aspects in accordance with various embodiments. As will be appreciated, although a Web-based environment is used for purposes of explanation, different environments may be used, as appropriate, to implement various embodiments. The environment includes an electronic client device 602, which can include any appropriate device operable to send and receive requests, messages, or information over an appropriate network 604 and convey information back to a user of the device. Examples of such client devices include personal computers, cell phones, handheld messaging devices, laptop computers, set-top boxes, personal data assistants, electronic book readers, and the like. The network can include any appropriate network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 606 for receiving requests and serving content in response thereto, although for other networks an alternative device serving a similar purpose could be used as would be apparent to one of ordinary skill in the art.

The illustrative environment includes at least one application server 608 and a data store 610. It should be understood that there can be several application servers, layers, or other elements, processes, or components, which may be chained or otherwise configured, which can interact to perform tasks such as obtaining data from an appropriate data store. As used herein the term “data store” refers to any device or combination of devices capable of storing, accessing, and retrieving data, which may include any combination and number of data servers, databases, data storage devices, and data storage media, in any standard, distributed, or clustered environment. The application server can include any appropriate hardware and software for integrating with the data store as needed to execute aspects of one or more applications for the client device, handling a majority of the data access and business logic for an application. The application server provides access control services in cooperation with the data store and is able to generate content such as text, graphics, audio, and/or video to be transferred to the user, which may be served to the user by the Web server in the form of HyperText Markup Language (“HTML”), Extensible Markup Language (“XML”), or another appropriate structured language in this example. The handling of all requests and responses, as well as the delivery of content between the client device 602 and the application server 608, can be handled by the Web server. It should be understood that the Web and application servers are not required and are merely example components, as structured code discussed herein can be executed on any appropriate device or host machine as discussed elsewhere herein.

The data store 610 can include several separate data tables, databases or other data storage mechanisms and media for storing data relating to a particular aspect. For example, the data store illustrated includes mechanisms for storing production data 612 and user information 616, which can be used to serve content for the production side. The data store also is shown to include a mechanism for storing log data 614, which can be used for reporting, analysis, or other such purposes. It should be understood that there can be many other aspects that may need to be stored in the data store, such as for page image information and to access right information, which can be stored in any of the above listed mechanisms as appropriate or in additional mechanisms in the data store 610. The data store 610 is operable, through logic associated therewith, to receive instructions from the application server 608 and obtain, update or otherwise process data in response thereto. In one example, a user might submit a search request for a certain type of item. In this case, the data store might access the user information to verify the identity of the user and can access the catalog detail information to obtain information about items of that type. The information then can be returned to the user, such as in a results listing on a Web page that the user is able to view via a browser on the user device 602. Information for a particular item of interest can be viewed in a dedicated page or window of the browser.

Each server typically will include an operating system that provides executable program instructions for the general administration and operation of that server and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 6. Thus, the depiction of the system 600 in FIG. 6 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
receiving, at an application associated with a backend processing system, an interaction from a client device, the interaction including a request for the application to cause the backend processing system to perform an action using one or more services;
providing, to the client device, an interactive user interface for requesting one or more consents for entity data to be collected or used based at least in part on the action;
receiving, from the client device and based at least in part on the interactive user interface, an indication of affirmative consent provided by an entity for the one or more consents;
determining, based at least in part on the action, one or more first categories for which the one or more services are configured to collect and use the entity data;
determining, based at least in part on the affirmative consent, one or more second categories for which the entity has agreed to allow the entity data to be collected and used;
mapping the one or more second categories to the one or more first categories to generate a set of categories for which the application or the one or more services are allowed to collect and use the entity data, the set of categories comprising a set of collection categories and/or a set of usage categories;
executing the application using the set of collection categories to collect a subset of the entity data according to the affirmative consent provided by the entity;
tagging the subset of the entity data with the set of collection categories and the set of usage categories to generate a tagged subset of the entity data; and
executing the one or more services to perform the action using the tagged subset of the entity data.

2. The computer-implemented method of claim 1, further comprising:
receiving an updated indication of affirmative consent from the client device, the updated indication of affirmative consent indicating different categories than the one or more second categories; and
adjusting the set of categories by (i) removing a subset of the set of categories that is not consistent with the different categories and/or (ii) adding one or more categories to the set of categories that are included in the different categories.

3. The computer-implemented method of claim 2, further comprising:
adjusting tags applied to the tagged subset of the entity data based at least in part on the adjusted set of categories;
determining that at least some of the tagged subset of the entity data is no longer consented to be stored by the entity; and
deleting the at least some of the tagged subset of the entity data.

4. The computer-implemented method of claim 1, wherein executing the one or more services comprises (i) executing a first service of the one or more services on the tagged subset of the entity data and (ii) transmitting the tagged subset of the entity data and a result of executing the first service to a second service of the one or more services, and wherein the computer-implemented method further comprises transmitting the set of usage categories to prevent the second service from using the tagged subset of the entity data in an unauthorized manner.

5. A computer system comprising:
a memory configured to store computer-executable instructions; and
a processor in communication with the memory and configured to execute the computer-executable instructions to perform operations comprising:
receiving, from a client device, an indication of affirmative consent provided by an entity for one or more consents for collecting and/or using entity data associated with performing an action that is performable by one or more services;
determining, based at least in part on the action, one or more first categories for which the one or more services are configured to collect and use the entity data;
determining, based at least in part on the affirmative consent, one or more second categories for which the entity has agreed to allow the entity data to be collected and used;
mapping the one or more second categories to the one or more first categories to generate a set of categories for which the one or more services are allowed to collect and use the entity data;
executing the one or more services using a first subset of the set of categories to collect a subset of the entity data according to the affirmative consent provided by the entity;
tagging the subset of the entity data with the set of categories to generate a tagged subset of the entity data; and
executing, according to a second subset of the set of categories, the one or more services to perform the action using the tagged subset of the entity data.

6. The computer system of claim 5, wherein the operations further comprise:
receiving, at an application associated with a backend processing system configured to facilitate execution of the one or more services, an interaction from the client device, the interaction including a request for the application to cause the backend processing system to perform the action using one or more services; and
providing, to the client device, an interactive user interface for requesting the one or more consents for the entity data to be collected or used based at least in part on the action.

7. The computer system of claim 5, wherein the first subset of the set of categories comprises a set of collection categories that indicates one or more categories for which the entity has agreed to allow the entity data to be collected.

8. The computer system of claim 7, wherein the second subset of the set of categories comprises a set of usage categories that indicates one or more categories for which the entity has agreed to allow the entity data to be used, and wherein the first subset is applicable to a different portion of the subset of the entity data than the second subset.

9. The computer system of claim 5, wherein:
the affirmative consent includes (i) first consent automatically provided for data essential for functions to facilitate the action and (ii) second consent optionally provided for additional data associated with functions that are performable based at least in part on the additional data; and
the first consent and the second consent are appliable to separate data independently from one another.

10. The computer system of claim 5, wherein the operations further comprise:
receiving an updated indication of affirmative consent from the client device, the updated indication of affirmative consent indicating different categories than the one or more second categories; and
adjusting the set of categories based at least in part on the updated indication of affirmative consent.

11. The computer system of claim 10, wherein the operation of adjusting the set of categories comprises (i) removing a subset of the set of categories that is not consistent with the different categories and/or (ii) adding one or more categories to the set of categories that are included in the different categories.

12. The computer system of claim 5, wherein the operations further comprise:
adjusting tags applied to the tagged subset of the entity data based at least in part on the adjusted set of categories;
determining that at least some of the tagged subset of the entity data is no longer consented to be stored by the entity; and
deleting the at least some of the tagged subset of the entity data.

13. The computer system of claim 5, wherein the operation of executing the one or more services comprises (i) executing a first service of the one or more services on the tagged subset of the entity data and (ii) transmitting the tagged subset of the entity data and a result of executing the first service to a second service of the one or more services, and wherein the operations further comprise transmitting the second subset of the set of categories to prevent the second service from using the tagged subset of the entity data in an unauthorized manner.

14. The computer system of claim 5, wherein the operation of executing the one or more services using the first subset of the set of categories to collect the subset of the entity data according to the affirmative consent provided by the entity comprises augmenting the subset of the entity data with a category table that tracks, substantially contemporaneously with respect to any subsequent updates to affirmative consent, categories of each portion of data of the entity data.

15. A non-transitory computer-readable medium comprising instructions that are executable by a processing device for causing the processing device to perform operations comprising:
receiving, from a client device, an indication of affirmative consent provided by an entity for one or more consents for collecting and/or using entity data associated with performing an action that is performable by one or more services;
determining, based at least in part on the action, one or more first categories for which the one or more services are configured to collect and use the entity data;
determining, based at least in part on the affirmative consent, one or more second categories for which the entity has agreed to allow the entity data to be collected and used;
mapping the one or more second categories to the one or more first categories to generate a set of categories for which the one or more services are allowed to collect and use the entity data;
executing the one or more services using a first subset of the set of categories to collect a subset of the entity data according to the affirmative consent provided by the entity;
tagging the subset of the entity data with the set of categories to generate a tagged subset of the entity data; and
executing, according to a second subset of the set of categories, the one or more services to perform the action using the tagged subset of the entity data.

16. The non-transitory computer-readable medium of claim 15, wherein the operation of executing the one or more services comprises (i) executing a first service of the one or more services on the tagged subset of the entity data and (ii) transmitting the tagged subset of the entity data and a result of executing the first service to a second service of the one or more services, and wherein the operations further comprise transmitting the second subset of the set of categories to prevent the second service from using the tagged subset of the entity data in an unauthorized manner.

17. The non-transitory computer-readable medium of claim 15, wherein the operation of executing the one or more services using the first subset of the set of categories to collect the subset of the entity data according to the affirmative consent provided by the entity comprises augmenting the subset of the entity data with a category table that tracks, substantially contemporaneously with respect to any subsequent updates to affirmative consent, categories of each portion of data of the entity data.

18. The non-transitory computer-readable medium of claim 15, wherein each category of the set of categories comprises a purpose sub-category that is mapped to the affirmative consent.

19. The non-transitory computer-readable medium of claim 15, wherein the first subset of the set of categories comprises a set of collection categories that indicates one or more categories for which the entity has agreed to allow the entity data to be collected.

20. The non-transitory computer-readable medium of claim 19, wherein the second subset of the set of categories comprises a set of usage categories that indicates one or more categories for which the entity has agreed to allow the entity data to be used, and wherein the first subset is applicable to a different portion of the subset of the entity data than the second subset.
